(19) United States
(12) Patent Application Publication
(10) Pub. No.: US 2005/0039689 A1
(43) Pub. Date: Feb. 24, 2005

(54) Device for receiving animal food

(76) Inventor: Raimund Mossmer, Munchen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/503,847

(22) PCT Filed: Feb. 6, 2003
(86) PCT No.: PCT/EP03/01172

(30) Foreign Application Priority Data
Feb. 7, 2002 (DE) 202 01 891.1

(51) Int. Cl. A01K 1/10

(52) U.S. Cl. 119/61.5

(57) ABSTRACT

The invention relates to a device for receiving animal food, especially pet food, comprising a base element comprising a standing device and a bowl-shaped cavity, and a bowl-shaped insert element which can be introduced into the base element in order to accommodate the animal food. The base element comprises a cone-shaped shoulder extending in an angular manner on the upper end thereof. The insert element comprises an edge area adapted to the cone-shaped shoulder of the base element. The outer periphery of the base element comprises at least one holding element for securing the insert element. An edge of the insert element is introduced into a receiving slit between the angularly extending shoulder of the base element and the holding element. The at least one holding element comprises at least one retaining element embodied in a projection-like manner, arranged above the receiving slit and the receiving slit protrudes in the direction of the bowl-shaped cavity, whereby an edge area of the insert element which can be introduced into the receiving slit can be fixed.

The invention relates to a device for receiving animal food, in particular food for household pets, having a base part with a stand and a bowl-like cavity, and having a bowl-like insert part which can be introduced into the base part and is formed for receiving the animal food.

A device of the generic type is known from DE 297 14 477 A1.

The device of the generic type has a base part with a stand and a bowl-like cavity. An insert part essentially in the form of the bowl-like cavity can be inserted into the latter for receiving animal food.

Provided on the base part is a fastening arrangement which extends at least over subregions of the outer circumference of the base part and by means of which the insert part can be fastened on the base part, the intention thus being to avoid the situation where the insert part slips out of the base part as the animal is feeding.

The document of the generic type here provides that the base part has a horizontally running flat collar on which the insert-part periphery which encloses the opening of the insert part rests. The periphery of the insert part is thus of flange-like design. The fastening arrangement causes the bearing surface of the collar of the base part to be partially reduced at some locations. An insert-part-fixing clamping action between the insert part and the base part in the region of the fastening arrangement is produced here in that the external diameter of the flange-like periphery of the insert part is designed to be larger than the external diameter of the collar of the base part in the region of the fastening arrangement. As a result, in the region of the fastening arrangement, a pressing zone is formed by the excess material of the insert part, with the result that the insert part lifts up in this region and repositions itself alongside the pressing zone. The insert part is thus secured against lifting off from the base part and also against rotating in relation to the base part.

FIG. 4 of the document of the generic type describes a clamping part which is connected to the base part by means of a flexible connecting location and has a link member and a clamping head. A protuberance is formed on the insert part for this purpose, the protuberance engaging in an aperture of the clamping head when the latter is in the swung-in state. In order to fasten the insert part on the base part, the clamping part is guided, by way of its clamping head, over the protuberance until the latter latches into the aperture and the clamping part is secured against swinging back of ist own accord.

The document of the generic type presents a significant improvement in comparison with the other known devices for receiving animal food, reference being made here to U.S. Pat. Nos. 5,445,110 A and 5,577,461 A.

The disadvantage with the document of the generic type, however, is that, when the animal is feeding, leftovers land on the periphery of the insert part and pass or drop down from there onto the base part, this resulting in corresponding soiling. A further disadvantage of the document of the generic type is that, when the insert part is removed from the base part, the base part and/or the surroundings are usually soiled.

The arrangement for fastening the base part on the insert part has indeed proven to be suitable, but has also proven to be worthy of improvement in terms of handling. This also applies in respect of cost-effective and straightforward production. The clamping elements have proven to be laborious in practice and, as far as the production costs are concerned, are too expensive for mass production.

The object of the present invention is thus to improve further the known devices for receiving animal food, in particular to provide a device for receiving animal food which is straightforward and cost-effective to produce, further reduces soiling, ensures straightforward and quick fastening and removal of the insert part from the base part and allows straightforward use and advantageous handling.

This object is achieved according to the invention by the features mentioned in the characterising part of claim 1.

Since the base part has a conical collar which tapers at an angle at the top end, and the insert part has a peripheral region adapted to this collar, it is ensured that leftover food, rather than resting on the peripheral region, as far as possible drops back again into the receiving region of the insert part. Since the insert part is fitted over the conical collar of the base part in the outward direction, this collar is protected against being soiled by leftover food. Once the insert part has been removed, the base part thus remains clean and unsoiled. A new insert part can then easily be introduced into the base part.

In contrast to the devices which are known from the prior art, soiling of the base part is reliably prevented since the insert part is drawn over the base part, or over the collar of the base part, in the outward direction.

Since the insert part can be fixed or fastened by at least one retaining member arranged on the outer circumference of the base part, the insert part is reliably retained in the cavity of the base part. Arranging the retaining member so as to produce a receiving slot for receiving the periphery of the insert part between the tapered collar of the base part and the retaining member allows particularly reliable fixing and, moreover, ensures that the periphery of the insert part can easily be introduced into the receiving slot. In order to introduce the insert part into the base part, the insert part can easily be positioned on the base part. Exerting light pressure on the periphery of the insert part and/or on the floor of the insert part causes the periphery of the insert part to be pressed into the receiving slot. The retaining member fixes the introduced insert part by way of the receiving slot and a restraining member of protrusion-like design. The restraining member here may be formed such that the insert part can simply be pressed in, although subsequent removal requires a defined application of force. The restraining member, for this purpose, is arranged above the receiving slot and projects into the diameter region of the insert part and projects beyond the receiving slot in the direction of the bowl-like cavity.

In one possible embodiment, the restraining member can extend over the entire width of the retaining member. The retaining member here may be of, for example, pylon-shaped design and have a slightly curved surface. The restraining member preferably has, on the bottom side, a sharp edge for the interengagement and/or interlocking of the insert part which is to be introduced and/or the peripheral region thereof.

Providing the restraining member over the entire width of the top edge of the retaining member avoids soiled corners.

In a further configuration, the restraining member may be designed as a restraining nose (for example in the form of a hawk nose). The restraining nose here may have an—already mentioned—sharp bottom edge for the interengagement of the insert part. The angle on the underside of the restraining nose here may be identical to the angle of the restraining member extending over the entire width of the retaining member.

The angled or conical configuration of the collar in this region allows or assists straightforward introduction into the receiving slots.

If appropriate, it may also be provided that the angled configuration of the periphery of the insert part differs slightly from the angled configuration of the collar of the base part such that the periphery of the insert part has a more acute angle, this already providing for a certain clamping action with the collar.

It is advantageous to provide four retaining members distributed uniformly along the outer circumference of the base part.

Such a configuration has proven to be particularly suitable in respect of advantageous and cost-effective fastening and of straightforward introduction of the periphery of the insert part.

In a development of the invention, it may further be provided that the cavity of the base part has two opposite holes.

The holes allow the insert part to be removed particularly easily from the base part. For this purpose, the base part is raised in the customary manner and transported, for example, to a garbage can. There, the base part is rotated and, by means of the two holes, it is possible, for example using the fingers of one hand, to thrust or push the insert part in order to press the latter out of the base part (the restraining force of the receiving slot and of the restraining member being overcome). Soiling of the base part or soiling of the person removing the insert part from the base part is reliably avoided. There is thus no need to use a knife or fingernails in order to remove the insert part laboriously and with high outlay from the top side of the base part. The holes make it possible to carry out the pressing-out process analogously, but in reverse order, to the pressing-in process. The base part is kept clean and can be provided with a new insert part immediately afterwards.

Advantageous configurations and developments of the invention can be gathered from the rest of the subclaims and from the exemplary embodiment which is illustrated in principle hereinbelow with reference to the drawing, in which:

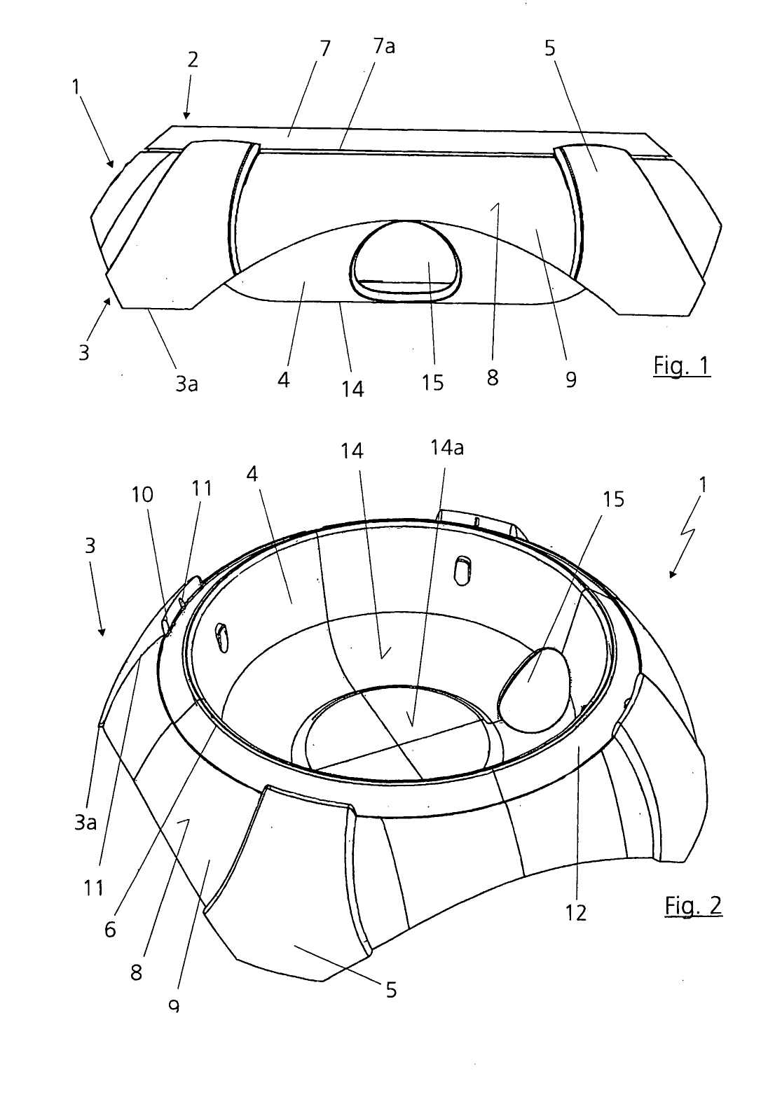

FIG. 1 shows a side view of the device according to the invention having a base part and an insert part inserted into the base part;

FIG. 2 shows a perspective view of the base part;

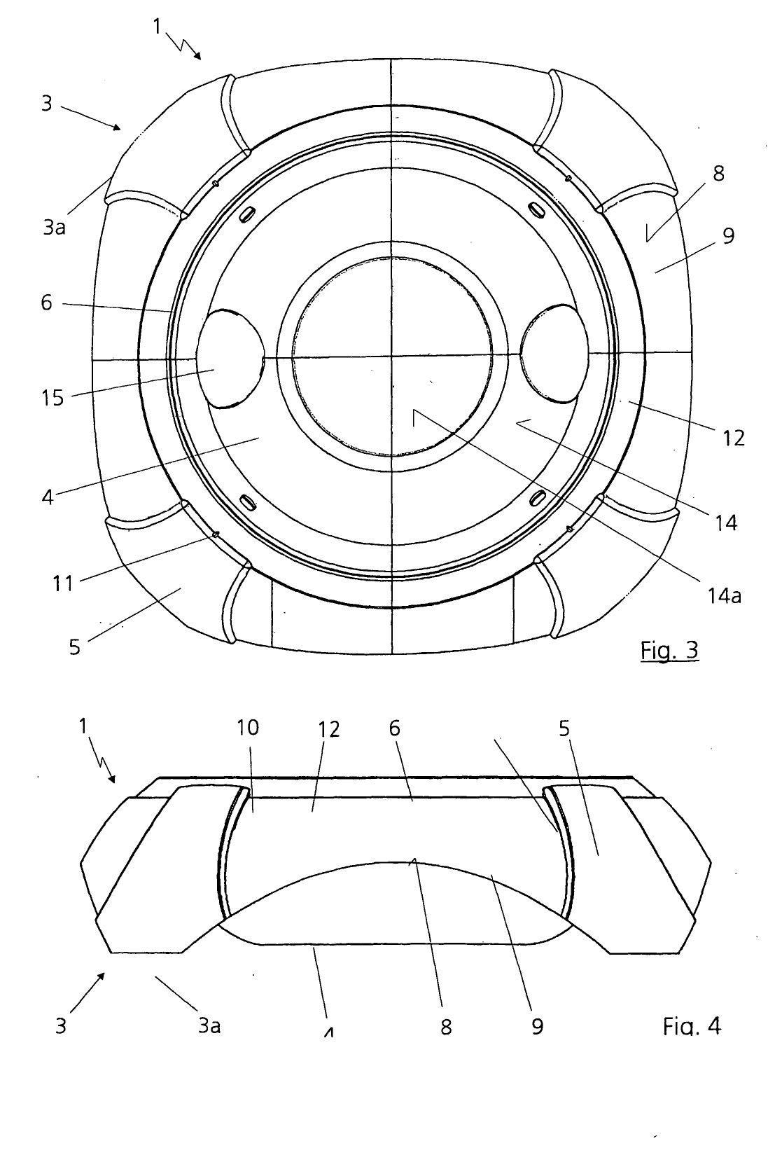

FIG. 3 shows a plan view of the base part;

FIG. 4 shows a side view of the base part;

FIG. 5 shows an illustration, in detail form, of a retaining member with a restraining member;

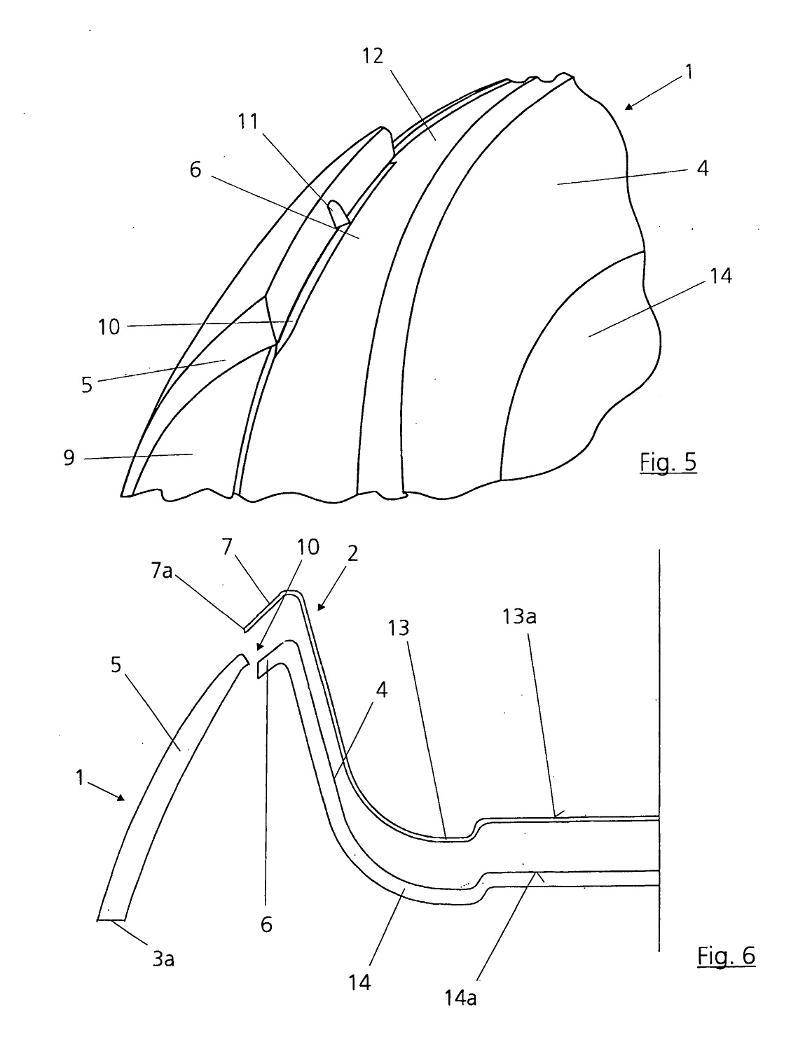

FIG. 6 shows a section through the insert part and the base part in a first phase of the pressing-in operation;

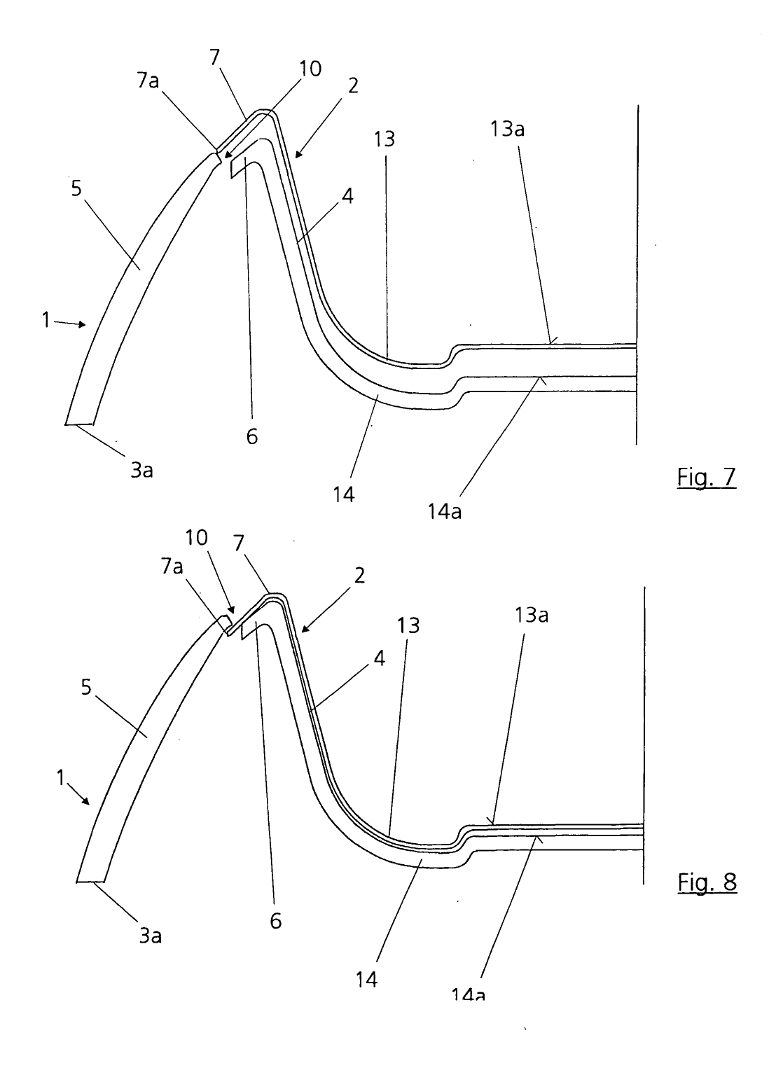

FIG. 7 shows a section through the insert part and the base part in a second phase of the pressing-in operation; and

FIG. 8 shows a section through the insert part and the base part in a third phase of the pressing-in operation.

Devices for receiving animal food, in particular for food for household pets, are already known in principle, reference being made to DE 297 14 477, for which reason it is only the features which are pertinent to the invention which will be discussed in any more detail hereinbelow.

As can be seen from FIG. 1, the device according to the invention has a base part 1 and an insert part 2. The base part 1 here has a stand 3 and a bowl-like cavity 4 for accommodating the insert part 2, the cavity being formed for receiving the animal food. For fastening or for retaining the insert part 2 in the base part 1, the base part 1 has four retaining members 5. The retaining members 5 here, as can be seen from FIGS. 2 and 3, are distributed uniformly over the outer circumference of the base part 1.

In the present exemplary embodiment, the retaining members 5 are formed, in the manner of pylons, integrally with the base part 1.

As can be seen from FIGS. 2 to 8, the base part 1 is provided at the top end with a conical collar 6 which tapers at an angle. As can be seen from FIGS. 1 and 6 to 8, the insert part 2 has its peripheral region 7 adapted to the conical collar 6 of the base part 1. The insert part 2, which is illustrated in section in FIGS. 5 to 8, can thus easily be fitted, by way of its peripheral region 7, over the base part 1, which is likewise illustrated in section, to produce the device according to the invention in FIG. 1. The operation of pressing the insert part 2 into the base part 1, or of fixing it therein, is illustrated in three different phases in FIGS. 6 to 8. The adapted, tapering peripheral region 7 of the insert part 2 reliably protects the base part 1 against being soiled by leftover food. The conical configuration, moreover, means that it is highly probable that leftover food drops back again into the inset part 2.

The retaining member is adapted more or less to the profile of the outer side 8 of the side walls 9, i.e. to the outer circumference of the base part 1. As can be seen particularly well from FIGS. 2 and 5, the tapering collar 6 of the base part 1 and the retaining members 5 form a receiving slot 10 for receiving the periphery 7a of the insert part 2.

The insert part 2 or the peripheral region 7 of the insert part 2 is connected to the base part 1, and fixed thereon, by the receiving slot 10 and by restraining members 11, which are arranged on the retaining members 5 above the receiving slot 10. The restraining force of the restraining members 11 or of the receiving slot 10 here is selected such that the insert part 2 is not released as a result of the animal feeding.

In the exemplary embodiment illustrated, the restraining members are designed as restraining noses 11. It is advantageous here if the restraining noses 11 are arranged centrally on the retaining members 5 (in relation to the horizontal extent of the retaining members). The restraining noses 11 preferably extend in the vertical direction.

The restraining noses 11 extend in the direction of the bowl-like cavity 4 and penetrate into the circumferential region or the diameter region of the insert part 2. The provision of four restraining noses 11 results in the circle diameter formed by these restraining noses 11 being smaller than the external diameter of the periphery 7a, with the result that, once the insert part 2 or the peripheral region 7a has been introduced into the receiving slots 10, it is prevented from accidentally slipping out or becoming detached as a result of the animal feeding.

Straightforward introduction of the periphery 7a of the insert part 2 into the receiving support 10 is assisted by the restraining noses 11 tapering upward.

In an embodiment which is not illustrated, the restraining noses 11 may also be designed in the form of barbs. This basic idea is also assisted by the upwardly tapering configuration of the restraining noses 11, as can be gathered from the exemplary embodiment.

In alternative embodiments, it may be provided that the restraining noses 11 also extend horizontally or terminate horizontally in the manner of protrusions. In further alternative embodiments, it may also be provided that each retaining member 5 has a plurality of restraining noses 11.

Various embodiments of the restraining noses 11, or of the restraining members in general, which allow straightforward introduction of the insert part 2, and correspondingly prevent the latter from slipping out, are conceivable to the person skilled in the art.

The restraining noses 11 can easily be produced by being molded integrally with the base part 1. It is also the case here that various production methods are obvious to the person skilled in the art.

Arranging the restraining noses 11 on the top end side of the retaining members 5 has proven to be particularly suitable. It is likewise advantageous if the retaining members 5 project or protrude some way beyond the receiving gap 10.

The base part 1 can easily be produced integrally, for example from plastic, with the retaining members 5. It is particularly advantageous for this purpose if on the outer sides 8 of the side walls 9, in the region of the collar 6, the base part 1 has an encircling groove or a recess 12 which corresponds at least more or less to the thickness of the peripheral region 7 of the insert part 2 and is provided for receiving the same (see, for example, FIG. 4).

It is advantageous here if the retaining members 5 project into the recess 12 (see FIGS. 2 to 4). The receiving slot 10 of the retaining members 5 may be designed, for example, such that the periphery 7a of the insert part 2 can penetrate by 1 to 10 mm, preferably 3 mm.

As can be gathered from FIGS. 6 to 8, the insert part 2 can be connected in a form-fitting manner to the base part 1. An appropriate selection of the conically tapering angle of the collar 6 of the base part 1 and of the peripheral region 7 of the insert part 2 makes it possible to achieve a clamping action between these. The clamping here can also be influenced by the angle of the retaining members (FIG. 8).

The illustrated formation of the base part 1, in particular the cavity 4, ensures that the insert part 2 is supported by the base part 1 in the filled state. The insert part 2 may thus be produced from brittle, biodegradable materials, for example pressed corn, without it being possible for the insert part 2 to be damaged under the weight of the animal food, thus losing ist function.

Of course, it is at the discretion of the person skilled in the art if the insert part 2 is to be produced from a recyclable material, for example waste paper. In the exemplary embodiment illustrated, it is provided that the insert part 2 is formed from compostable, preferably molded paper. In a manner which is not illustrated, the insert part 2 may be provided with a likewise preferably compostable film. The film here can ensure that the animal which is to be fed does not accidentally swallow or tear off bits of the insert part 2.

For straightforward stackability, or in order for it to be possible for the insert part 2 to be transported easily, the floor 13 of the insert part 2 may have a plateau-like elevation 13a. As has been found in tests, significantly better stackability is achieved as a result of the plateau-like elevation 13a.

For advantageous fastening of the insert part 12, it is provided here that the base part 1 also has, on its floor 14, a plateau-like elevation 14a, which is adapted to the plateau-like elevation 13a. Of course, it is also possible for the plateau-like elevation 13a of the insert part 2 to be adapted to the plateau-like elevation 14a of the base part 1. Since the insert part 2 is a disposable product, however, its stackability is more important than the stackability of the base part 1, which nevertheless, of course, can also be transported in a space-saving manner in relatively large quantities for sales purposes.

As has likewise been found in tests, the plateau-like elevation 14a of the base part 1 and the corresponding plateau-like elevation 13a of the insert part 2 also provide for particularly good connection. Moreover, a correspondingly variable contour of the plateau-like elevations 13a and 14a can ensure, if required, that the insert part 2 can only be inserted in a certain way into the base part 1.

As can be gathered from FIGS. 1 to 3, the base part 1 has two opposite holes 15 in the bottom region of the bowl-like cavity 4. The holes 15 allow the insert part 2 to be easily removed from the base part 1 again if required. The arrangement of the holes 15 here ensures advantageous single-handed operation. By virtue of simply pushing one's fingers into the holes 15, the pressing-in operation is reversed and the insert part 2 is released from the base part 1 counter to the retaining force of the receiving slots 10 and/or of the restraining noses 11.

As can be seen from FIGS. 1 to 4, in particular FIG. 1, the retaining members 5 are formed, by a corresponding vertical extension, as standing surfaces 3a of the stand 3. Tests have shown this to be particularly advantageous and straightforward to produce.

The side walls 9, forming the outer circumference of the base part 1, between the standing surfaces 3a and/or the clamping elements 5 are of upwardly curved or arcuate design (see FIGS. 1, 2 and 4).

On the one hand, the arcuate configuration of the side walls 9 makes it possible to dispense with separate handles for transporting the base part 1 since the base part 1 can easily be transported by using one's hands to grip the region of the curved side walls.

On the other hand, the curved side walls 9, as can be seen from FIG. 1 for example, allow the holes 15 to be easily reached. There is thus no need to feel for the latter; rather, they are clearly visible, in particular also in the rotated state of the device according to the invention, in which the insert part 2 is generally ejected from the base part 1.

As can be gathered from FIGS. 1 and 2, the retaining members 5 have, at their top end, a slightly curved shape which slopes down somewhat to the lateral end sides. As a result, if the insert part 2 should become caught in any way during the introduction, this takes place only at certain points, on account of the slightly rounded form, rather than over the entire surface area.

Tests have shown that a relatively stiff configuration of the insert part 2 is particularly advantageous.

The plateau-like elevation 13a and the plateau-like elevation 14a can also be used as adjusting means.

1-18. (CANCELED).

19. A device for receiving animal food, in particular food for household pets, having a base part with a stand and a bowl-like cavity, and having a bowl-like insert part which can be introduced into the base part and is formed for receiving the animal food, wherein:
a) the base part (1) has a conical collar (6) which tapers at an angle at the top end,
b) the insert part (2) has a peripheral region (7) adapted to the conical collar (6) of the base part (1),
c) the outer circumference of the base part (1) has at least one retaining member (5) for fixing the insert part (2),
d) a periphery (7a) of the insert part (2) can be introduced into a receiving slot (10) between the tapering collar (6) of the base part
(1) and the retaining member (5), and
e) the at least one retaining member (5) has at least one restraining member (11) which is of protrusion-like design, is arranged above the receiving slot (10) and projects beyond the receiving slot (10) in the direction of the bowl-like cavity (4), as a result of which it is possible to fix a peripheral region (7) of the insert part (2), it being possible for this peripheral region to be introduced into the receiving slot (10).

20. The device according to claim 19, wherein the provision of four retaining members (5) distributed uniformly along the outer circumference of the base part (1).

21. The device according to claim 19, wherein the retaining members (5) are formed integrally with the base part (1).

22. The device according to claim 19, wherein the restraining members have, on their underside, a sharp edge for the interengagement or interlocking of a peripheral region (7a) of the insert part (2) which can be introduced therein, and are preferably designed as restraining noses (11).

23. The device according to claim 22, wherein the restraining noses (11), in relation to the horizontal extent of the retaining members (5), are arranged preferably centrally on the latter and extend largely in the vertical direction.

24. The device according to claim 22, wherein the restraining noses (11) taper upward such that the peripheral region (7) of the insert part (2) can easily be introduced into the receiving slot (10) and fixed.

25. The device according to claim 19, wherein the receiving slots (10) of the retaining members (5) allow the periphery (7a) of the insert part (2) to penetrate by 1 to 10 mm, preferably 3 mm.

26. The device according to claim 19, wherein the outer circumference, in the region of the collar (6), the base part (1) has an encircling groove or a recess (12) which corresponds at least more or less to the thickness of the peripheral region (7) of the insert part (2) and is provided for receiving the same.

27. The device according to claim 26, wherein the insert part (2) can be connected in a form-fitting manner to the base part (1).

28. The device according to claim 19, wherein the base part (1), in the bottom region of the bowl-like cavity (4), has at least one cut-out, a bore, a hole (15) or the like.

29. The device according to claim 28, wherein the cavity (4) has two opposite holes (15).

30. The device according to claim 19, wherein the retaining members (5) are formed, by a corresponding vertical extension, as standard surfaces (3a) of the stand (3).

31. The device according to claim 30, wherein the side walls (9), forming the outer circumference of the base part (1), between the standing surfaces (3a) and/or the retaining members (5) are of curved or arcuate design.

32. The device according to claim 31, wherein the arcuate side walls (9) are designed as handles and ensure that the holes (15) can easily be reached.

33. The device according to claim 19, wherein the region of the center of a floor (14) of the cavity (4) of the base part (1) is a plateau-like elevation (14a) which projects into the cavity (4).

34. The device according to claim 33, wherein the floor (13) of the insert part (2) has a plateau-like elevation (13a) adapted to the plateau-like elevation (14a).

35. The device according to claim 19, wherein the insert part (2) can be composted and is preferably formed from molded paper.

36. The device according to claim 19, wherein the insert part (2) is provided with a preferably compostable film.
